(19) United States
(12) Patent Application Publication
(10) Pub. No.: US 2026/0204453 A1
(43) Pub. Date: Jul. 16, 2026

(54) CABLE COMPRISING LAYER OF CROSSLINKABLE POLYETHYLENE COMPOSITION WITH IMPROVED CROSSLINKING SPEED

(71) Applicant: Borealis AG, Vienna (AT)

(72) Inventors: Tina Gschneidtner, Stenungsund (SE); Martin Anker, Stenungsund (SE)

(21) Appl. No.: 19/131,282

(22) PCT Filed: Nov. 23, 2023
(86) PCT No.: PCT/EP2023/082868

§ 371 Date: May 20, 2025

(30) Foreign Application Priority Data
Nov. 23, 2022 (EP) 22209163.9

(51) Int. Cl. H01B 3/44; C08J 3/24

(52) U.S. Cl. CPC H01B 3/441; C08J 3/247; C08J 2323/08; C08J 2423/08

(57) ABSTRACT

The present invention relates to cable comprising a layer comprising a crosslinkable polyethylene composition comprising one or more ethylene copolymer(s) containing monomer units with polar groups and monomer units with hydrolysable silane groups, wherein the monomer units with polar groups are present in an amount of 0.02 to 25 mol. %, and a sulphonic acid, wherein the layer thickness is at least 0.9 mm.

### BACKGROUND OF THE INVENTION

The present invention relates to cables, particularly to low voltage (LV) and medium voltage (MV) cables, comprising a layer comprising a crosslinkable polyethylene composition wherein the layer is comparatively thick.

Electric power cables for low voltages, i.e. voltages of below 6 kV, usually comprise an electric conductor which is coated with an insulation layer. Such a cable is also referred to as single wire cable. Optionally, two or more of such single wire cables are surrounded by a common outermost sheath layer, the jacket.

The insulation layer of low voltage power cables usually is made of a polymer composition comprising a polymer base resin, such as a polyolefin. A material commonly used as a base resin is polyethylene. Furthermore, in the final cable the polymer base resin usually is crosslinked.

For this and other applications such as for welding cables or electric vehicle charging cables today primarily peroxide crosslinked EPR (ethylene-propylene rubber) is used. However, the manufacturing process of these cables is very complicated as one needs to crosslink first the insulation in a vulcanisation tube and then apply the jacket and once again let it go through the vulcanisation tube for crosslinking the jacket. Accordingly, most commonly both the insulation and the jacket is crosslinked for these kind of flexible cables. For standard non-flexible cables, only the insulation is crosslinked.

A different approach to provide crosslinking in layers for cables is, for example, disclosed in WO 00/68957 A1, where a cable having at least one insulating or protecting layer consisting of a crosslinked ethylene-alkyl (meth)acrylate-unsaturated silane terpolymer composition, such as a ethylene-alkyl (meth)acrylate-vinyl trialkoxysilane terpolymer, is disclosed. In these type of composition the silanol groups can be crosslinked by moisture curing.

There is a continuous need to provide such polyethylene compositions with an improved crosslinking behaviour, e.g. in terms of the time needed for crosslinking the material, especially at ambient temperatures.

For example, EP 2251365 A1 and EP 2363267 A1 disclose that using vinyl tri (acetoxy) silane as a comonomer in ethylene terpolymer yields an improved hydrolysis reactivity of acylsilanes vs alkoxysilanes, which leads to a higher crosslinking speed.

It is, accordingly, the object of the present invention to provide a polyethylene composition for layers in a cable which shows an improved crosslinking speed, in particular when crosslinking is effected at ambient temperatures and wherein the layers of the cable have a comparatively high thickness, such as a thickness of 0.9 mm or higher.

### SUMMARY OF THE INVENTION

The present invention is based on the finding that this object can be achieved and a cable with a layer which has a thickness of at least 0.9 mm and which contains a polyethylene containing crosslinkable silane groups and polar comonomer units can be provided which shows a highly improved crosslinking speed, in particular when crosslinked at ambient temperatures, if a sulphonic acid silanol condensation catalyst is used in the composition.

The present invention thus provides a cable comprising a layer comprising, or consisting of, a crosslinkable polyethylene composition comprising, or consisting of,
(A1) one or more ethylene copolymer(s) containing monomer units with polar groups and monomer units with hydrolysable silane groups, wherein the monomer units with polar groups are present in an amount of 0.02 to 25 mol. %, preferably from 1 to 15 mol. %, more preferably from 2.5 to 15 mol. %, preferably from 4 to 12 mol. % based on the total polyethylene composition, and
(B) a sulphonic acid,
wherein the layer thickness is at least 0.9 mm, preferably at least 1.2 mm, more preferably at least 2.0 mm, and most preferably is at least 3.0 mm. The layer thickness is preferably up to 8.0 mm, preferably in the range of from 1.2 mm to 5.5 mm, preferably in the range of from 1.4 mm to 3.6 mm, preferably in the range of 2.4 mm to 3.6 mm. Preferably for a low voltage cable (<6 kV) the thickness is in the range of 1.2 mm to 3.0 mm, preferably in the range 2.4 mm to 3.0 mm. Preferably for a medium voltage cable (>6 kV to 68 kV) the thickness is greater than 3.00 mm and up to 8.0 mm, preferably in the range of from 3.2 mm to 5.5 mm, preferably in the range 3.2 mm to 3.6 mm.

The cable of the present invention shows a highly improved crosslinking behaviour such as a highly increased crosslinking speed in the crosslinkable layer comprising the crosslinkable polyethylene composition, in particular when crosslinking is effected at ambient temperatures, and this effect is even more pronounced when the layer thickness increases.

Apparently, this effect is caused by a synergy between the sulphonic acid used as a silanol condensation catalyst and the crosslinkable polyethylene composition used in the cable layer, which is not present when other known silanol condensation catalysts, such as e.g. tin-containing catalysts, are used.

Ambient temperature is usually defined to be from 20° C. to 25° C., most preferably 23° C.

### DETAILED DESCRIPTION OF THE INVENTION

The polyolefin composition of the present invention comprises, or consists of, one or more ethylene copolymer(s)(A1). Preferably, the polyolefin composition comprises, or consists of two ethylene copolymers (A1) which differ from each other.

The one or more ethylene copolymer(s)(A1) containing monomer units with polar groups may for example be produced by grafting of a polyolefin with a polar-group containing compound, i.e. by chemical modification of the polyolefin polymer by addition of a polar group containing compound mostly in a radical reaction. Grafting is e.g. described in U.S. Pat. Nos. 3,646,155 and 4,117,195.

It is, however, preferred that the one or more polyolefin copolymer(s)(a) is produced by copolymerization of ethylene in the presence of monomer units with polar groups and monomer units with hydrolysable silane groups.

In the case of copolymerization, the complete monomer unit with polar groups is designated by the expression “monomer units with polar groups”. Thus, the weight fraction of the monomer unit with polar groups in the polyolefin copolymer which has been obtained by copolymerization may simply be calculated by using the weight ratio of the monomers units with polar groups that have been polymerized into the polyolefin copolymer. For example, where an ethylene copolymer comprising polar groups is produced by copolymerization of ethylene monomers with a vinyl compound comprising a polar group, also the vinyl part, which after polymerization forms part of the polymer backbone, contributes to the weight fraction of the “monomer unit with polar groups”.

Preferably, the monomer units with polar groups are selected from siloxane, amide, anhydride, carboxylic, carbonyl, hydroxyl, ester and/or epoxy group.

As examples of monomer units with polar groups may be mentioned the following: (a) vinyl carboxylate esters, such as vinyl acetate, vinyl pivalate, and mixtures thereof; (b)(meth)acrylates, such as methyl (meth)acrylate, ethyl (meth)acrylate, butyl (meth)acrylate, hydroxyethyl (meth)acrylate, and mixtures thereof; (c) olefinically unsaturated carboxylic acids, such as (meth)acrylic acid, maleic acid, fumaric acid, and mixtures thereof; (d)(meth)acrylic acid derivatives, such as (meth)acrylonitrile, (meth)acrylic amide, and mixtures thereof; and (e) vinyl ethers, such as vinyl methyl ether, vinyl phenyl ether, and mixtures thereof.

Amongst these monomers, vinyl esters of monocarboxylic acids having 1 to 4 carbon atoms, such as vinyl acetate, and (meth)acrylates of alcohols having 1 to 4 carbon atoms, such as methyl (meth)acrylate, and mixtures thereof are preferred.

Especially preferred monomers are butyl acrylate, ethyl acrylate, methyl methacrylate, methyl acrylate and/or and mixtures thereof. Two or more such olefinically unsaturated compounds may be used in combination. The term “(meth)acrylic acid” is intended to embrace both acrylic acid and methacrylic acid.

Preferably, the monomer units with polar groups are present in an amount of 0.02 to 25 mol. %, preferably from 0.1 to 20 mol. %, more preferably from 0.2 to 15 mol. %, more preferably from 1.0 to 15 mol. %, more preferably from 2.5 to 15 mol. %, preferably from 4 to 12 mol. %, and most preferably from 7 to 12 mol. % based on the total polyethylene composition.

In particular, where also component (A2) in any one of the embodiments as described herein below is present in the polyethylene composition, the monomer units with polar groups are preferably present in an amount of 1 to 15 mol. %, more preferably 4 to 15 mol. %, even more preferably 7 to 12 mol, based on the total polyethylene composition.

Apart from monomer units with polar groups, the one or more ethylene copolymer(s) (a) also contain(s) monomer units with hydrolysable silane-groups. These silane-groups may be introduced into the polymer either via grafting, as e.g. described in U.S. Pat. Nos. 3,646,155 and 4,117,195, or preferably via copolymerization of ethylene in the presence of monomer units with polar groups and monomer units with hydrolysable silane groups.

In cases where a copolymerization is used, the complete monomer with silane groups is designated by the expression “monomer unit with hydrolysable silane-groups”.

Preferably, the ethylene copolymer (a) has been obtained by copolymerization. The copolymerization is preferably carried out with monomer unit with hydrolysable silane-groups represented by the formula

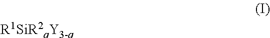

wherein
R¹ is an ethylenically unsaturated hydrocarbyl, hydrocarbyloxy or (meth)acryloxy hydrocarbyl group,
R² is an aliphatic saturated hydrocarbyl group, Y which may be the same or different, is a hydrolysable organic group and q is 0, 1 or 2.

Special examples of the monomer unit with hydrolysable silane-groups are those wherein R¹ is vinyl, allyl, isopropenyl, butenyl, cyclohexanyl or gamma-(meth)acryloxy propyl; Y is methoxy, ethoxy, formyloxy, acetoxy, propionyloxy or an alkyl- or arylamino group; and R², if present, is a methyl, ethyl, propyl, decyl or phenyl group.

A preferred monomer unit with hydrolysable silane groups is represented by the formula

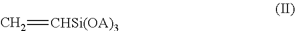

wherein A is a hydrocarbyl group having 1-8 carbon atoms, preferably 1-4 carbon atoms.

The most preferred monomer units with hydrolysable silane groups are vinyl trimethoxysilane, vinyl bismethoxyethoxysilane, vinyl triethoxysilane, gamma-(meth)acryloxypropyltrimethoxysilane, gamma(meth)acryloxypropyltriethoxy-silane, and vinyl triacetoxysilane.

The copolymerization of ethylene in the presence of monomer units with polar groups and the monomer units with hydrolysable silane groups may be carried out under any suitable conditions resulting in the copolymerization of ethylene and the two monomer units. The resulting ethylene copolymer(s)(A1) can thus also be labelled as terpolymer(s).

Preferably, the monomer units with hydrolysable groups are present in an amount of 0.001 wt. % to 15 wt. %, more preferably 0.01 wt. % to 5 wt. %, and most preferably 0.1 wt. % to 2 wt. % based on the total polyethylene composition.

Preferably, the one or more ethylene copolymer(s) of (A1) has a MFR_{2.16} of from 1 g/10 min to 50 g/10 min, preferably of from 2 g/10 min to 45 g/10 min, preferably from 3.0 g/10 min to 40 g/10 min as determined according to ISO 1133 at a temperature of 190° C. and a load of 2.16 kg.

The crosslinkable polyolefin composition in the layer of cable of the present invention comprises a sulphonic acid as a silanol condensation catalyst (component (B)).

Preferably, the sulphonic acid is present in an of 0.0001 to 9 wt. %, more preferably of 0.0005 to 7 wt. %, still more preferably 0.001 to 5 wt. %, even more preferably 0.005 to 4 wt. %, even more preferably 0.01 to 3 wt. % even more preferably 0.025 to 2 wt. % and most preferably 0.05 to 1 wt. % based on the total polyethylene composition.

Preferably, the sulphonic acid comprising 10 C-atoms or more, more preferably 12 C-atoms or more, and most preferably 14 C-atoms or more, the sulphonic acid further comprising at least one aromatic group which may e.g. be a benzene, naphthalene, phenantrene or anthracene group. In the organic sulphonic acid, one, two or more sulphonic acid groups may be present, and the sulphonic acid group(s) may either be attached to a non-aromatic, or preferably to an aromatic group, of the organic sulphonic acid.

Further preferred, sulphonic acid comprises the structural element:

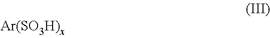

with Ar being an aryl group which may be substituted or non-substituted, and x being at least 1, such as 1, 2 or 3.

The organic aromatic sulphonic acid silanol condensation catalyst may comprise the structural unit according to formula (III) one or several times, e.g. two or three times. For example, two structural units according to formula (III) may be linked to each other via a bridging group such as an alkylene group.

Preferably, Ar is a aryl group which is substituted with at least one C₄— to C₃₀-hydrocarbyl group, more preferably C₄— to C₃₀-alkyl group.

Aryl group Ar preferably is a phenyl group, a naphthalene group or an aromatic group comprising three fused rings such as phenantrene and anthracene.

Preferably, in formula (III) x is 1, 2 or 3, and more preferably x is 1 or 2.

Furthermore, preferably the compound used as organic aromatic sulphonic acid silanol condensation catalyst has from 10 to 200 C-atoms, more preferably from 14 to 100 C-atoms.

In one preferred embodiment, Ar is a hydrocarbyl substituted aryl group and the total compound containing 14 to 28 carbon atoms, and still further preferred, the Ar group is a hydrocarbyl substituted benzene or naphthalene ring, the hydrocarbyl radical or radicals containing 8 to 20 carbon atoms in the benzene case and 4 to 18 atoms in the naphthalene case.

It is further preferred that the hydrocarbyl radical is an alkyl substituent having 10 to 18 carbon atoms and still more preferred that the alkyl substituent contains 12 carbon atoms and is selected from dodecyl and tetrapropyl. Due to commercial availability it is most preferred that the aryl group is a benzene substituted group with an alkyl substituent containing 12 carbon atoms.

The currently most preferred compounds are dodecyl benzene sulphonic acid and tetrapropyl benzene sulphonic acid.

The silanol condensation catalyst may also be precursor of the sulphonic acid compound, including all its preferred embodiments mentioned, i.e. a compound that is converted by hydrolysis to such a compound. Such a precursor is for example the acid anhydride of a sulphonic acid compound, or a sulphonic acid that has been provided with a hydrolysable protective group, as e.g. an acetyl group, which can be removed by hydrolysis.

In a second preferred embodiment, the sulphonic acid catalyst is selected from those as described in EP 1 309 631 and EP 1 309 632, namely
a) a compound selected from the group of
(i) an alkylated naphthalene monosulfonic acid substituted with 1 to 4 alkyl groups wherein each alkyl group is a linear or branched alkyl with 5 to 40 carbons with each alkyl group being the same or different and wherein the total number of carbons in the alkyl groups is in the range of 20 to 80 carbons;
(ii) an arylalkyl sulfonic acid wherein the aryl is phenyl or naphthyl and is substituted with 1 to 4 alkyl groups wherein each alkyl group is a linear or branched alkyl with 5 to 40 carbons with each alkyl group being the same or different and wherein the total number of carbons in the alkyl groups is in the range of 12 to 80;
(iii) a derivative of (i) or (ii) selected from the group consisting of an anhydride, an ester, an acetylate, an epoxy blocked ester and an amine salt thereof which is hydrolysable to the corresponding alkyl naphthalene monosulfonic acid or the arylalkyl sulfonic acid;
(iv) a metal salt of (i) or (ii) wherein the metal ion is selected from the group consisting of copper, aluminium, tin and zinc; and
b) a compound selected from the group of
(i) an alkylated aryl disulfonic acid selected from the group consisting of the structure (IV):

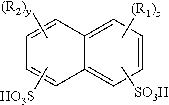

### And the Structure (V):

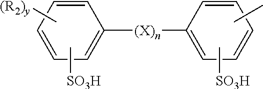

wherein each of R₁ and R₂ is the same or different and is a linear or branched alkyl group with 6 to 16 carbons, y is 0 to 3, z is 0 to 3 with the proviso that y+z is 1 to 4, n is 0 to 3, X is a divalent moiety selected from the group consisting of —C(R₃)(R₄)—, wherein each of R₃ and R₄ is H or independently a linear or branched alkyl group of 1 to 4 carbons and n is 1; —C(═O)—, wherein n is 1; —S—, wherein n is 1 to 3 and —S(O)₂—, wherein n is 1; and
(ii) a derivative of (i) selected from the group consisting of the anhydrides, esters, epoxy blocked sulfonic acid esters, acetylates, and amine salts thereof which is a hydrolysable to the alkylated aryl disulfonic acid,
together with all preferred embodiments of those sulphonic acids as described in the mentioned European Patents.

Further preferred, sulphonic acid is an acid according to formula (VI)

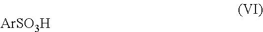

or a precursor thereof, Ar being a hydrocarbyl substituted aryl group and the total compound containing 14 to 28 carbon atoms.

Preferably, the Ar group is a hydrocarbyl substituted benzene or naphthalene ring, the hydrocarbyl radical or radicals containing 8 to 20 carbon atoms in the benzene case and 4 to 18 atoms in the naphthalene case.

It is further preferred that the hydrocarbyl radical is an alkyl substituent having 10 to 18 carbon atoms and still more preferred that the alkyl substituent contains 12 carbon atoms and is selected from dodecyl and tetrapropyl. Due to commercial availability it is most preferred that the aryl group is a benzene substituted group with an alkyl substituent containing 12 carbon atoms.

Preferably, the sulphonic acid based catalyst comprises dodecyl benzene sulphonic acid, tetrapropyl benzene sulphonic acid, alkylated naphthalene sulphonic acid, arylalkyl sulphonic acid, alkylated aryl disulphonic acid or mixtures thereof, preferably consists of dodecyl benzene sulphonic acid or tetrapropyl benzene sulphonic acid.

The silanol condensation catalyst may also be precursor of a compound of formula (VI), i.e. a compound that is converted by hydrolysis to a compound of formula (VI). Such a precursor is for example the acid anhydride of the sulphonic acid compound of formula (VI). Another example is a sulphonic acid of formula (VI) that has been provided with a hydrolysable protective group as e.g. an acetyl group which can be removed by hydrolysis to give the sulphonic acid of formula (VI).

The silanol condensation catalyst is preferably added as a crosslinking catalyst masterbatch (CM) to the crosslinkable polyolefin composition of the invention. The masterbatch preferably comprises the above-described silanol condensation catalyst and a polymeric carrier, and optionally other additives such as an antioxidant. The polymeric carrier is preferably an ethylene copolymer, more preferably a copolymer of ethylene and a monomer containing alkyl acrylate groups, and most preferably an ethylene butylacrylate copolymer.

The crosslinkable polyolefin composition furthermore preferably comprises a copolymer of ethylene and a C₃ to C₈ alpha-olefin co-monomer (A2) having a density of from 850 to 970 kg/m³ and a MFR₂ of from 0.1 to 50 g/10 min, determined according to ISO 1133 at a temperature of 190° C. and a load of 2.16 kg.

If ethylene copolymer (A2) is present in the crosslinkable polyethylene composition, the effect of an improved crosslinking behaviour, e.g. in terms of the crosslinking time needed, is especially pronounced.

Accordingly, in a preferred embodiment the crosslinkable polyethylene composition of the layer in the cable of the invention comprises, or consists of, components (A1), (A2) and (B) in any one of their embodiments as described herein.

The ethylene copolymer (A2) may encompass high density, medium density, low density and even very low density ethylene copolymers. It may preferably have a density in the range of from 850 to 970 kg/m³, more preferably from 860 to 930 kg/m³, even more preferably from 860 kg/m³ to 915 kg/m³.

The ethylene copolymer (A2) may preferably have a MFR₂ of 0.5 to 25 g/10 min, more preferably of 1.0 to 15 g/10 min, even more preferably of 1.5 to 10 g/10 min, measured according to ISO 1133.

The ethylene copolymer (A2) is preferably a copolymer of ethylene with a C₃ to C₁₂ alpha-olefin co-monomer, such as propylene, 1-butene, 1-hexene, 1-octene and 1-decene. More preferably it is a copolymer of ethylene and 1-octene. The copolymer of ethylene and 1-octene may preferably have a density in the range of 850 kg/m³ to 930 kg/m³, more preferably in the range of 855 kg/m³ to 920 kg/m³, even more preferably in the range of from 870 kg/m³ to 910 kg/m³, measured according to ISO 1183-187.

Preferably, ethylene-1-butene or ethylene-1-octene copolymers (plastomers) can be used. Any copolymer of ethylene and 1-butene or 1-octene having the above defined properties may be used. Preferred materials are commercially available, i.a. from Borealis under the tradename Queo, from DOW Chemical Corp (USA) under the tradename Engage or Affinity, or from Mitsui Chemicals under the tradename Tafmer.

Alternatively, these plastomers can be prepared by known processes, in a one stage or two stage polymerization process, comprising solution polymerization, slurry polymerization, gas phase polymerization or combinations therefrom, in the presence of suitable catalysts, like vanadium oxide catalysts or single-site catalysts, e.g. metallocene or constrained geometry catalysts, known to the person skilled in the art. Preferably, metallocene type catalysts are used.

Preferably, these plastomers are prepared by a one stage or two stage solution polymerization process, especially by high temperature solution polymerization process at temperatures higher than 100° C.

Such process is essentially based on polymerizing the monomer and a suitable comonomer in a liquid hydrocarbon solvent in which the resulting polymer is soluble. The polymerization is carried out at a temperature above the melting point of the polymer, as a result of which a polymer solution is obtained. This solution is flashed in order to separate the polymer from the unreacted monomer and the solvent. The solvent is then recovered and recycled in the process.

Preferably, the solution polymerization process is a high temperature solution polymerization process, using a polymerization temperature of higher than 100° C. More preferably, the polymerization temperature is at least 110° C., even more preferably at least 150° C. The polymerization temperature can be up to 250° C.

The pressure in such a solution polymerization process is preferably in a range of 10 to 100 bar, more preferably 15 to 100 bar and even more preferably 20 to 100 bar. The liquid hydrocarbon solvent used is preferably a C₅₋₁₂-hydrocarbon which may be unsubstituted or substituted by C₁₋₄ alkyl group such as pentane, methyl pentane, hexane, heptane, octane, cyclohexane, methylcyclohexane and hydrogenated naphtha. More preferably, unsubstituted C₆₋₁₀-hydrocarbon solvents are used.

A known solution technology suitable for the process according to the invention is the Borceed™ technology.

The crosslinkable polyethylene composition in the cable comprising a layer comprising the crosslinkable polyethylene composition preferably has a density of 915 kg/m³ or higher, more preferably of 920 kg/m³ or higher, and most preferably of 925 kg/m³ or higher.

Usually, the density of the crosslinkable polyethylene composition is 970 kg/m³ or lower.

The polyolefin composition in the cable comprising a layer comprising the crosslinkable polyethylene composition can be crosslinked.

Preferably, cross-linking is performed at ambient temperature.

The crosslinking is preferably carried out by so-called moisture curing as is known in the art. Reference is made to e.g. WO 95/17463 and WO 00/36612. In a first step, the silane groups of the ethylene copolymer(s) are hydrolyzed under the influence of water or steam, resulting in the splitting-off of alcohol and the formation of silanol groups. In a second step, the silanol groups are crosslinked by a condensation reaction splitting off water. In both steps, the silanol condensation catalyst as described herein may preferably be used as catalyst.

Crosslinking is preferably carried out at ambient conditions, preferably at 45% to 65% relative humidity and a temperature of 20° C. to 25° C., most preferably at 55% relative humidity and a temperature of 23° C.

The crosslinkable polyolefin composition in the cable comprising a layer comprising the crosslinkable polyethylene composition may preferably have a hot set elongation of not more than 180%, more preferably of not more than 100%, even more preferably of not more than 80%, determined according to IEC 60811-507, by measuring thermal deformation at 200° C. and at a load of 20 N/cm².

The crosslinkable polyolefin composition in the cable comprising a layer comprising the crosslinkable polyethylene composition may preferably have a hot set elongation of not less than 10%, more preferably of not less than 15%, even more preferably of not less than 20%, determined according to IEC 60811-507, by measuring thermal deformation at 200° C. and at a load of 20 N/cm². Each of the lower limits may be combined with each of the upper limits indicated for hot set elongation.

The cable of the present invention preferably is a low voltage (LV) or medium voltage (MV) cable.

The at least one layer of the cable is preferably an insulation layer or a sheath layer.

The present invention is further directed to a process for cross-linking the crosslinkable polyethylene composition of a layer of a cable according to any one of the embodiments described herein wherein cross-linking is performed at ambient temperature.

Preferably, in the process of the present invention the cross-linking time to reach a degree of hot set elongation of 100% or lower is 100 hours or less, more preferably is 75 hours or less and most preferably is 50 hours or less.

Furthermore, preferably, in the process of the present invention the cross-linking time to reach a degree of hot set elongation of 80% or lower, more preferably of 70% or lower and most preferably of 60% or lower is 100 hours or less.

The present invention still further is directed to the use of a crosslinkable polyethylene composition in any one of the embodiments as described herein in a layer with a thickness of at least 0.9 mm of a cable in any one of the embodiments as described herein for cross-linking at ambient temperature, preferably ambient conditions, at increased speed.

The present invention is further described in the following by way of examples and by referring to the figures.

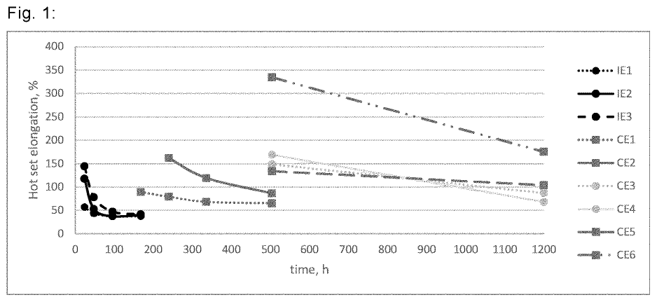

FIG. 1 shows the hot set elongation as a function of the time for tapes with different thicknesses of Ethylene Polymer Composition (A) and comparative compositions.

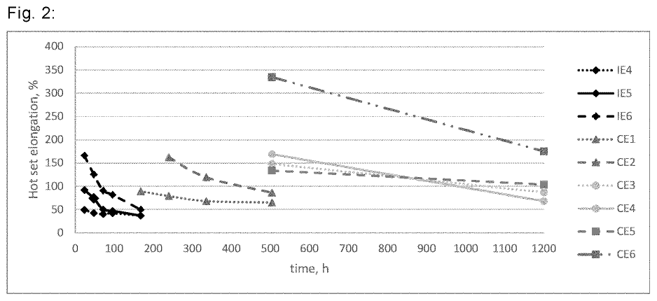

FIG. 2 shows the hot set elongation as a function of the time for tapes with different thicknesses of Ethylene Polymer Composition (B) and comparative compositions.

### EXAMPLES

### 1. Determination Methods

### a) Melt Flow Rate (MFR)

The melt flow rate (MFR) was determined according to ISO 1133 and was indicated in g/10 min. The MFR is an indication of the flowability, and hence the processability, of the polymer. The higher the melt flow rate, the lower the viscosity of the polymer.

The MFR₂ of polyethylene (co-)polymers was measured at a temperature 190° C. and at a load of 2.16 kg.

### b) Density

Density of the polymer was measured according to ISO 1183-1:2004 Method A on compression moulded specimen prepared according to EN ISO 1872-2 and is given in kg/m³

### c) Comonomer Content

### Quantification of Microstructure by NMR Spectroscopy

Quantitative nuclear-magnetic resonance (NMR) spectroscopy was used to quantify the comonomer content of the polymer.

Quantitative ¹H NMR spectra recorded in the molten-state using a Bruker Avance III 500 NMR spectrometer operating at 500.13 MHz. All spectra were recorded using a 13C optimised 7 mm magic-angle spinning (MAS) probe head at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed using a recycle delay of 2s {pollard04, klimke06}. A total of 16 transients were acquired per spectra.

Quantitative ¹H NMR spectra were processed, integrated and quantitative properties determined using custom spectral analysis automation programs. All chemical shifts were internally referenced to the bulk ethylene methylene signal at 1.33 ppm.

### Assignment for Methylacrylate (MA) Incorporation {Brandolini01}:

Characteristic signals resulting from incorporation of methyl acrylate, in possible various comonomer sequences, were observed. The overall methylacrylate incorporation was quantified using the integral of the signal at 3.6 ppm assigned to the 1MA site, accounting for the number of reporting nuclei per comonomer:

$$MA = {I}_{1 MA} / 3$$

The ethylene content was quantified using the integral of the bulk aliphatic (I_{bulk}) signal between 0.00-3.00 ppm. The total ethylene content was calculated based on the bulk integral and compensating for the observed comonomer:

$$E = ( 1 / 4 ) * [ {I}_{b u l k} - 3 * MA ]$$

The total mole fractions of methylacrylate in the polymer was calculated as:

$$fMA = MA / ( E + MA )$$

The total comonomer incorporations of methylacrylate in mole percent was calculated from the mole fraction in the standard manner:

$$MA [ mol . \% ] = 100 * fMA$$

The total comonomer incorporations of methylacrylate in weight percent was calculated from the mole fractions in the standard manner:

$$MA [ wt \% ] = 100 * ( fMA * 86.09 ) / ( ( fMA * 86.09 ) + ( ( 1 - fMA ) * 28. 05 ) )$$

klimke06: Klimke, K., Parkinson, M., Piel, C., Kaminsky, W., Spiess, H. W., Wilhelm, M., Macromol. Chem. Phys. 2006; 207:382.
parkinson07: Parkinson, M., Klimke, K., Spiess, H. W., Wilhelm, M., Macromol. Chem. Phys. 2007; 208:2128.
pollard04: Pollard, M., Klimke, K., Graf, R., Spiess, H. W., Wilhelm, M., Sperber, O., Piel, C., Kaminsky, W., Macromolecules 2004; 37:813.
castignolles09: Castignolles, P., Graf, R., Parkinson, M., Wilhelm, M., Gaborieau, M., Polymer 50 (2009) 2373.
brandolini01: A. J. Brandolini, D. D. Hills, “NMR spectra of polymers and polymer additives”, Marcel Deker Inc., 2000.

### d) FTIR

The amount of vinyl trimethoxy silane in the polymers was measured by Fourier Transform Infrared Spectroscopy (FTIR). The wt. % of vinyl trimethoxy silane was determined from the peak for silane at 945 cm-1, which was compared to the peak of polyethylene at 2665 cm-1.

### e) Hot Set Elongation (%)

To determine that the crosslinkable polyethylene composition are properly cured the hot set elongation and permanent set were determined according to IEC 60811-507, by measuring thermal deformation at 200° C. at a load of 20 N/cm². Three dumb-bell test samples are prepared from a tape consisting of a polyethylene composition to be tested by cutting test samples from the tape. Each test sample was fixed vertically from upper end thereof in the oven and the load of 20 N/cm² were attached to the lower end of each test sample. After 15 min, 200° C. in oven the distance between the premarked lines is measured and the percentage hot set elongation is calculated and expressed as Hot Set elongation in %.

For permanent set %, the tensile force (weight) is removed from the test samples and after recovered in 200° C. for 5 minutes and then let to cool in room temperature to ambient temperature. The permanent set % is calculated from the distance between the marked lines.

### f) Tensile Strength

2. Tensile strength was determined according to ISO 527-2 (cross head speed=50 mm/min; 23° C.) using compression molded specimens as described in EN ISO 1873-2 (dog bone shape, 2 mm. Materials

In the examples of the present invention, the following materials have been used:
Ethylene polymer (a1) is a terpolymer of ethylene (76.1 wt.-%), methyl acrylate (22.5 wt.-%) and vinyl trimethoxysilane (1.4 wt.-%), having a density of 945 kg/m³ and a MFR₂ (190° C., 2.16 kg) of 3.5 g/10 min.
Ethylene polymer (a2) is a copolymer of ethylene and 1-octene, having a density of 902 kg/m³, a MFR₂ (190° C., 2.16 kg) of 1.1 g/10 min, a flexural modulus of 72 MPa, a tensile strength of 36 MPa, an elongation at break of 715% and a melting temperature Tm of 97° C. Ethylene copolymer (a2) is commercially available from Borealis AG, Vienna under the trade name Queo™ 0201.
Ethylene polymer (b) is a terpolymer of ethylene (89.45 wt.-%), butylacrylate (9.5 wt.-%) and vinyl trimethoxysilane (1.05 wt.-%), having a density of 922 kg/m³ and a MFR₂ (190° C., 2.16 kg) of 1.0 g/10 min.
Ethylene polymer (c) is an ethylene/vinyl trimethoxy silane (VTMS) copolymer having a density of 923 kg/m³, a MFR₂ of 1 g/10 min and a VTMS content of 1.1 wt. %.
MB1 is a catalyst masterbatch comprising a matrix resin (an ethylene butylacrylate copolymer with 17 wt. % butyl acrylate, a density of 924 kg/m³ and a MFR₂ of 47.0 g/10 min) and 1.5 wt % dodecyl benzene sulphonic acid.
MB2 is a catalyst masterbatch comprising a matrix resin (an ethylene butylacrylate copolymer with 17 wt. % butyl acrylate, a density of 924 kg/m³ and a MFR₂ of 47.0 g/10 min) and 2.4 wt % dioctyltindilaurate.

### Preparation of the Polymer Compositions

A polymer composition (A) from 85 wt. % of ethylene polymer (a1) and 15 wt. % of ethylene polymer (a2) was produced by mixing the components together in a BUSS-co-kneader (46 mm) at a screw speed of 225 rpm and at a set temperature of 40, 160, 180, 200° C. in the kneading section and at 200° C. in the pelletizing extruder. The mixer screw was heated to 120° C. The extruder screw temperature was 160° C., the barrel heated to 170° C. and the speed 4 rpm. All components were added in port 1.

Polymer compositions (B) and (C) correspond to 100 wt. % of ethylene polymer (b) and (c), respectively.

Before extrusion as further disclosed below, crosslinking catalyst masterbatches MB1 or MB2 were added at a concentration of 5 wt % to the respective compositions A, B and C.

### Manufacture of Tape

Tapes were produced for determination of the hot-set elongation produced on a Collin TeachLine E20T tape extruder with a 4.2:1, 20D compression screw with a 20 mm diameter with different thicknesses as indicated below.

The temperature profile was 150/160/170° C. and the screw speed was 55 rpm.

Before extrusion, crosslinking catalyst masterbatches MB1 or MB2 were added at a concentration of 5 wt % to all formulations.

The compositions tested are indicated in Table 1.

TABLE 1
Tested Polyethylene Compositions

| | Composition | Masterbatch | Tape |
|---|---|---|---|
| Example | (95 wt. %) | (5 wt. %) | thickness |
| IE1 | (A) | MB1 | 1.4 mm |
| IE2 | (A) | MB1 | 2.5 mm |
| IE3 | (A) | MB1 | 3.6 mm |
| IE4 | (B) | MB1 | 1.4 mm |
| IE5 | (B) | MB1 | 2.5 mm |
| IE6 | (B) | MB1 | 3.6 mm |
| CE1 | (C) | MB1 | 1.4 mm |
| CE2 | (C) | MB1 | 2.5 mm |
| CE3 | (A) | MB2 | 1.4 mm |
| CE4 | (A) | MB2 | 2.5 mm |
| CE5 | (C) | MB2 | 1.4 mm |
| CE6 | (C) | MB2 | 2.5 mm |

Prior to hot-set testing, the tapes were crosslinked at a humidity of 50% RH and at ambient temperature (23° C.) for the times as indicated in FIGS. 1 and 2.

The results of the hot set testing is shown in FIGS. 1 and 2. It can be seen from the slopes of the crosslinking curves for the Inventive Examples (IE1 to IE6) and Comparative Examples (CE1 to CE6) that the polyethylene composition contained in the layer of a cable according to the invention crosslinks extremely faster than when using a conventional polyethylene containing hydrolysable silane groups and/or a conventional tin-based silanol condensation catalyst. This effect is even more pronounced at higher thicknesses.

Further, the tensile strength of polymer (A) and polymer (B) was measured. Polymer (A) has a tensile strength of 16.5 MPA and polymer (B) has a tensile strength of 11 MPa. The addition of component a2) therefore further improves the tensile strength of the crosslinked polymer.

1. A cable comprising a layer comprising a crosslinkable polyethylene composition comprising
(A1) one or more ethylene copolymer(s) containing monomer units with polar groups and monomer units with hydrolysable silane groups, wherein the monomer units with polar groups are present in an amount of 0.02 to 25 mol. %, based on the total polyethylene composition, and
(B) a sulphonic acid,
wherein the layer thickness is at least 0.9 mm.

2. The cable according to claim 1, wherein the one or more ethylene copolymer(s) of (A1) has a MFR_{2.16} of from 1 g/10 min to 50 g/10 min, as determined according to ISO 1133 at a temperature of 190° C. and a load of 2.16 kg.

3. The cable according to claim 1, wherein component A1 is present in the polyethylene composition in an amount of 50 to 99 wt. %, based on the total polyethylene composition, and wherein the polyethylene composition further comprises
(A2) 1 to 50 wt. %, based on the total polyethylene composition, of a copolymer of ethylene and a C₃ to C₈ alpha-olefin co-monomer having a density of from 850 to 970 kg/m³ and a MFR_{2.16} of from 0.1 to 50 g/10 min, determined according to ISO 1133 at a temperature of 190° C. and a load of 2.16 kg.

4. The cable according to claim 1, wherein cross-linking is performed at ambient temperature.

5. The cable according to claim 1 wherein the monomer units with polar groups are selected from the group consisting of butyl acrylate, ethyl acrylate, methyl acrylate and methyl methacrylate, and mixtures thereof.

6. The cable according to claim 1, wherein the monomer units with hydrolysable silane groups are selected from the group consisting of vinyl trimethoxy silane, vinyl bismethoxyethoxy silane, vinyl triethoxy silane, gamma-(meth)acryl-oxypropyltrimethoxy silane, gamma(meth)acryloxypropyltriethoxy silane, vinyl triacetoxy silane and mixtures thereof.

7. The cable according to claim 1, wherein the monomer units with hydrolysable groups are present in the one or more ethylene copolymer(s)(a) in an amount of 0.001 wt. % to 15 wt. %, based on the total polyethylene composition.

8. The cable according to claim 1, wherein sulphonic acid (B) is present in in an amount of 0.0001 to 9 wt. %, based on the total polyethylene composition.

9. The cable according to claim 1, wherein sulphonic acid (B) is an aromatic organic sulphonic acid which comprises the structural element: 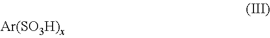
with Ar being an aryl group which may be substituted or non-substituted, and x being at least 1.

10. The cable according to claim 9, wherein Ar is a hydrocarbyl substituted aryl group, and wherein the sulphonic acid contains in total 14 to 28 carbon atoms.

11. The cable according to claim 9, wherein the at least one layer is an insulation layer or a sheath layer.

12. The cable according to claim 9, wherein the cable is a low voltage cable and the layer thickness is in the range of 1.2 mm to 3.0 mm or wherein the cable is a medium voltage cable and the layer thickness is greater than 3.00 mm and up to 8.0 mm.

13. A process for cross-linking the crosslinkable polyethylene composition of a layer of a cable according to claim 9 wherein cross-linking is performed at ambient temperature.

14. Process for cross-linking according to claim 13 wherein the cross-linking time to reach a degree of hot set elongation, determined according to IEC 60811-507 by measuring thermal deformation at 200° C. at a load of 20 N/cm², of 100% or lower is 100 hours or less.

15. Use of a crosslinkable polyethylene composition comprising
(A1) one or more ethylene copolymer(s) containing monomer units with polar groups and monomer units with hydrolysable silane groups, wherein the monomer units with polar groups are present in an amount of 0.02 to 25 mol. %, preferably from 1 to 15 mol. %, more preferably from 2.5 to 15 mol. %, based on the total polyethylene composition, and
(B) a sulphonic acid
in a layer with a thickness of at least 0.9 mm of a cable for cross-linking at ambient temperature at increased speed.

16. The cable according to claim 1, wherein the monomer units with polar groups are present in an amount of 4 to 12 mol. %.

17. The cable according to claim 1, wherein the layer thickness is at least 3.0 mm.

18. The cable according to claim 1, wherein the one or more ethylene copolymer(s) of (A1) has a MFR_{2.16} of from 3 g/10 min to 40 g/10 min.

19. The cable according to claim 10, wherein Ar is a C₈-C₂₀ hydrocarbyl substituted benzene or a C₁₄-C₁₈ hydrocarbyl substituted naphthalene
